(19) United States
(12) Patent Application Publication
(10) Pub. No.: US 2015/0345387 A1
(43) Pub. Date: Dec. 3, 2015

(54) PLANT CONTROL APPARATUS AND PLANT STARTING-UP METHOD

(71) Applicant: KABUSHIKI KAISHA TOSHIBA, Minato-ku (JP)

(72) Inventors: Masayuki TOBO, Kawasaki (JP); Keiichi NAKAMURA, Yokohama (JP); Sayaka YOSHIDA, Yokohama (JP)

(73) Assignee: KABUSHIKI KAISHA TOSHIBA, Minato-ku (JP)

(21) Appl. No.: 14/665,131

(22) Filed: Mar. 23, 2015

(30) Foreign Application Priority Data
May 30, 2014 (JP) 2014-113102

(51) Int. Cl. F02C 6/18; F02C 3/04; F01K 7/16

(52) U.S. Cl. CPC F02C 6/18; F01K 7/165; F02C 3/04

(57) ABSTRACT

In one embodiment, a plant control apparatus controls a combined cycle power generation plant. The plant includes a gas turbine, an exhaust heat recovery boiler including an evaporator to recover heat from an exhaust gas discharged from the gas turbine to generate steam and including a heat exchanger to exchange heat between the steam and an exhaust gas from the gas turbine and generate main steam, and a steam turbine driven by the main steam. The apparatus includes a control unit to increase output of the gas turbine to a target output after the gas turbine is paralleled with a generator. The target output is set so that an exhaust gas temperature of the gas turbine exceeds a maximum operating temperature of the exchanger and that a temperature of the exchanger becomes the maximum operating temperature or less by using a cooling effect given by the main steam.

### CROSS REFERENCE TO RELATED APPLICATION

This application is based upon and claims the benefit of priority from the prior Japanese Patent Application No. 2014-113102, filed on May 30, 2014, the entire contents of which are incorporated herein by reference.

### FIELD

Embodiments described herein relate to a plant control apparatus and a plant starting-up method.

### BACKGROUND

There is known a combined cycle power generation plant configured by combining a gas turbine, an exhaust heat recovery boiler and a steam turbine. The exhaust heat recovery boiler recovers heat from an exhaust gas from the gas turbine to generate steam. The steam turbine is driven by the steam generated by the exhaust heat recovery boiler.

### BRIEF DESCRIPTION OF THE DRAWINGS

FIG. 1 is a schematic structural view showing a configuration of a combined cycle power generation plant 500 of a first embodiment;

FIG. 2 is a schematic structural view showing a configuration of a plant control apparatus 501 of the first embodiment;

FIG. 3 is a flow chart showing a plant starting-up method in accordance with the first embodiment;

FIG. 4 is a graph showing a relationship between GT exhaust gas temperature and heat exchanger temperature at a prescribed generated flow rate F₁;

FIG. 5 is a startup chart of a plant starting-up method in accordance with the first embodiment;

FIG. 6 is a schematic structural view showing a configuration of a combined cycle power generation plant 600 in a comparative example;

FIG. 7 is a graph showing an example of a relationship between gas turbine output and the GT exhaust gas temperature;

FIG. 8 is a flow chart showing a plant starting-up method in accordance with the comparative example; and

FIG. 9 is a startup chart of a plant starting-up method in accordance with the comparative example.

### DETAILED DESCRIPTION

Embodiments will now be explained with reference to the accompanying drawings.

In order to advance start timing of a flow of steam into a steam turbine, it is conceived that gas turbine output is increased at an earlier stage than that in a conventional manner to early increase a main steam temperature to a predetermined temperature to start a flow of steam so that the steam turbine is early started up. However, since a maximum operating temperature is determined for a heat exchanger represented by a superheater that is built in an exhaust heat recovery boiler, it is necessary to prevent a temperature of the heat exchanger from exceeding the maximum operating temperature.

Specifically, if the exhaust heat recovery boiler sufficiently generates the main stream, the main steam supplied to the heat exchanger takes heat of an exhaust gas, so that a temperature of the heat exchanger does not become the maximum operating temperature. As a result, there is no problem even if a temperature of the exhaust gas from the gas turbine exceeds the maximum operating temperature. However, in a stage where the main steam is generated with an extreme low amount, the amount of the main steam to take heat of the exhaust gas from the gas turbine is low. As a result, the heat exchanger is not sufficiently cooled by the main steam so that a problem of so-called heating without steam may occur in the heat exchanger in which a temperature exceeds the maximum operating temperature.

In order to prevent this problem, it is conceived that output of the gas turbine that performs warming-up before steam flows into the steam turbine is selected so that a temperature of an exhaust gas from the gas turbine becomes a maximum within a range without exceeding the maximum operating temperature of the heat exchanger built in the exhaust heat recovery boiler. In this case, since startup time of a combined cycle power generation plant depends on gas turbine output, it is impossible to shorten the startup time more than a capability of the gas turbine.

In one embodiment, a plant control apparatus is configured to control a combined cycle power generation plant. The plant includes a gas turbine. The plant further includes an exhaust heat recovery boiler including an evaporator configured to recover heat from an exhaust gas discharged from the gas turbine to generate steam, and a heat exchanger configured to exchange heat between the steam and an exhaust gas from the gas turbine to heat the steam and generate main steam. The plant further includes a steam turbine configured to be driven by the main steam generated by the heat exchanger. The apparatus includes a control unit configured to increase output of the gas turbine to a target output after the gas turbine is paralleled with a generator. The target output is set so that an exhaust gas temperature of the gas turbine exceeds a maximum operating temperature of the heat exchanger and that a temperature of the heat exchanger becomes the maximum operating temperature of the heat exchanger or less by using a cooling effect given by the main steam.

### Comparative Example

In order to describe the first embodiment, first a combined cycle power generation plant in accordance with a comparative example will be described.

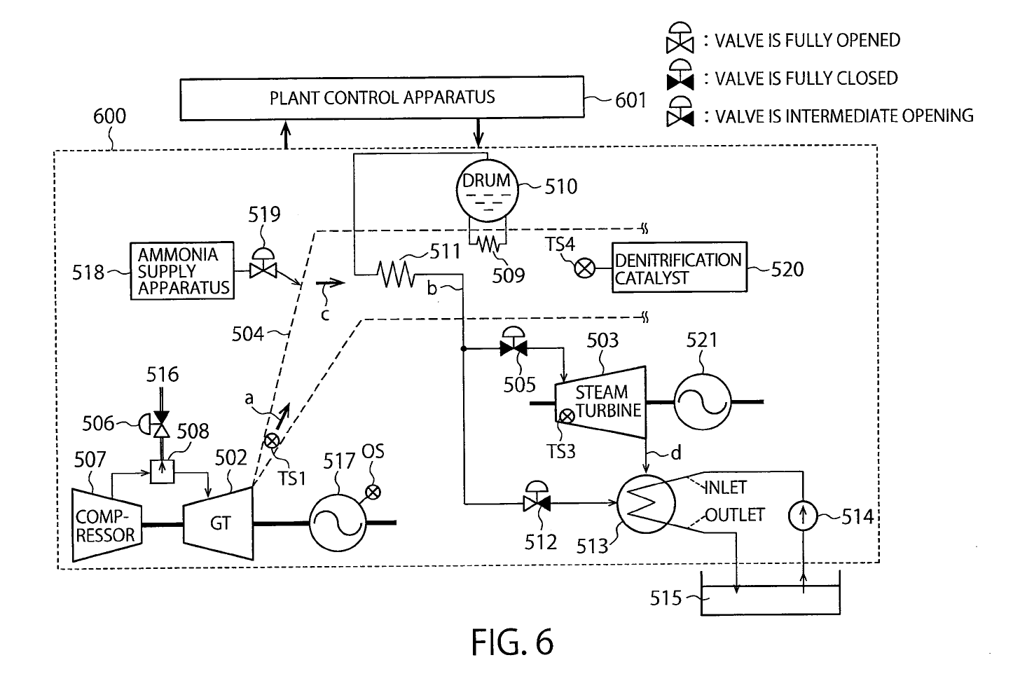

FIG. 6 is a schematic structural view showing a configuration of a combined cycle power generation plant 600 in the comparative example. Numeric values used in the description below are an example for easier understanding.

The combined cycle power generation plant 600 includes a gas turbine 502 and a steam turbine 503 each of which is composed of a different shaft.

A plant control apparatus 601 totally operates and controls the combined cycle power generation plant 600.

(Configuration of Combined Cycle Power Generation Plant 600)

The combined cycle power generation plant 600 includes a compressor 507, a gas turbine (GT) 502 connected to the compressor 507, and a generator 517 provided with a rotating shaft that is connected to the gas turbine 502.

In addition, the combined cycle power generation plant 600 includes a combustor 508 that burns fuel 516 together with air from the compressor 507. The fuel 516 is burned to generate gas at a high temperature and under high pressure and the generated gas is supplied to the gas turbine 502 from the combustor 508 to drive the gas turbine 502.

In piping through which the fuel 516 is supplied to the combustor 508, there is provided a fuel control valve 506 that opens and closes on the basis of a control signal from the plant control apparatus 601. It is possible to adjust the amount of the fuel 516 to be supplied to the combustor 508 by adjusting opening of the fuel control valve 506.

In addition, the combined cycle power generation plant 600 includes a GT output sensor OS that detects an output of the generator 517 at a prescribed time interval and that supplies a GT output signal showing the output of the generator 517 to the plant control apparatus 601.

Further, the combined cycle power generation plant 600 includes an exhaust gas temperature sensor TS1 that detects a temperature of a GT exhaust gas “a” discharged from the gas turbine (GT) 502 at a prescribed time interval, and that supplies an exhaust gas temperature signal showing a detected temperature of the GT exhaust gas “a” to the plant control apparatus 601.

Furthermore, the combined cycle power generation plant 600 includes an exhaust heat recovery boiler 504 that recovers heat from the GT exhaust gas “a” from the gas turbine 502 to generate steam.

Further yet, the combined cycle power generation plant 600 includes an evaporator 509 that recovers heat from the GT exhaust gas “a”, a drum 510 that is connected to the evaporator 509, and a heat exchanger 511 provided with a steam inflow port that is connected to a steam exhaust port of the drum 510 through piping. Here, the heat exchanger 511 is a superheater, for example.

Further yet, the combined cycle power generation plant 600 includes a control valve 505 provided with a steam inflow port that is connected to a steam exhaust port of the heat exchanger 511 through piping. The control valve 505 adjusts a flow rate of main steam from the heat exchanger 511 to the steam turbine in accordance with control by the plant control apparatus 601.

Further yet, the combined cycle power generation plant 600 includes the steam turbine 503 provided with a steam inflow port that is connected to a steam exhaust port of the control valve 505 through piping, and a generator 521 provided with a rotating shaft that is connected to a rotating shaft of the steam turbine 503.

Further yet, the combined cycle power generation plant 600 includes a turbine bypass control valve 512 provided with a steam inflow port that is connected to the steam exhaust port of the heat exchanger 511 through piping. The turbine bypass control valve 512 adjusts a steam flow rate from the heat exchanger 511 to a steam condenser 513 in accordance with control by the plant control apparatus 601.

Further yet, the combined cycle power generation plant 600 includes the steam condenser 513 that is provided with a steam inflow port that is connected to a steam exhaust port of the turbine bypass control valve 512 through piping, and with another input port that is connected to an exhaust port of the steam turbine 503 through piping, and that exchanges heat between water from its outlet and seawater. Exhaust steam “d” discharged from the steam turbine 503 flows into the steam condenser 513. The steam condenser 513 cools the exhaust steam “d” discharged from the steam turbine with seawater or air. For example, the steam condenser 513 cools the exhaust steam “d” by using seawater supplied by a circulating water pump 514.

In view of environmental conservation, the combined cycle power generation plant 600 has a denitrification apparatus.

The denitrification apparatus mixes an exhaust gas discharged from the gas turbine with an ammonia gas, and decomposes and removes nitrogen oxide (hereinafter referred to as a NOx) in the exhaust gas by using a denitrification catalyst. Here, the denitrification apparatus includes an ammonia supply apparatus 518, an ammonia supply valve 519, a denitrification catalyst 520, and a catalyst temperature sensor TS4.

The ammonia supply apparatus 518 discharges an ammonia gas “c”, and the discharged ammonia gas “c” is supplied to the exhaust heat recovery boiler 504 through the ammonia supply valve 519. The ammonia gas “c” supplied to the exhaust heat recovery boiler 504 is mixed with the GT exhaust gas “a” to react with NOx in the exhaust gas in the denitrification catalyst 520 so that NOx is decomposed and removed. In this way, a flow rate of NOx to be discharged in the atmosphere from the exhaust heat recovery boiler 504 is reduced.

The catalyst temperature sensor TS4 detects a temperature of the denitrification catalyst 520 at a prescribed time interval, and supplies a catalyst temperature signal showing the detected temperature of the denitrification catalyst 520 to the plant control apparatus 601.

(Operation of Combined Cycle Power Generation Plant 600)

Subsequently, operation of the combined cycle power generation plant 600 having the configuration above will be described. FIG. 6 shows an operating state of the combined cycle power generation plant 600 in which the control valve 505 is fully closed after ignition operation is performed in the gas turbine 502. Here, the fuel control valve 506 is in an intermediate opening position, and the turbine bypass control valve 512 is in an intermediate opening position, for example.

Fuel 516 for the gas turbine 502 flows from the fuel control valve 506 to be burned together with air from the compressor 507 in the combustor 508. The GT exhaust gas “a” at a high temperature flows into the exhaust heat recovery boiler 504 so that the evaporator 509 recovers heat from the GT exhaust gas “a”. As a result, steam is generated in the drum 510. The heat exchanger 511 exchanges heat between the generated steam and the GT exhaust gas “a” so that the generated steam is further heated to become main steam “b”. However, the control valve 505 of the steam turbine 503 is still closed, so that the steam turbine 503 does not start up yet. Because the main steam “b” has a temperature that is not high enough at a time when time does not elapse after ignition, the control valve 505 is not allowed to be opened to supply the main steam “b” into the steam turbine 503. Hereinafter, supplying the main steam “b” into the steam turbine 503 is referred to as a flow of steam.

The turbine bypass control valve 512 is opened to guide the main steam “b” from the heat exchanger 511 to the steam condenser 513 while controlling pressure thereof until a flow of steam is allowed. In the steam condenser 513, seawater 515 pumped up by the circulating water pump 514 is supplied, so that the main steam “b” flowing through the turbine bypass control valve 512 is cooled in the steam condenser 513 by the seawater 515. As a result, while the main steam “b” is condensed to become condensate, the seawater 515 with temperature rise caused by heat exchange with the main steam “b” is returned to the sea.

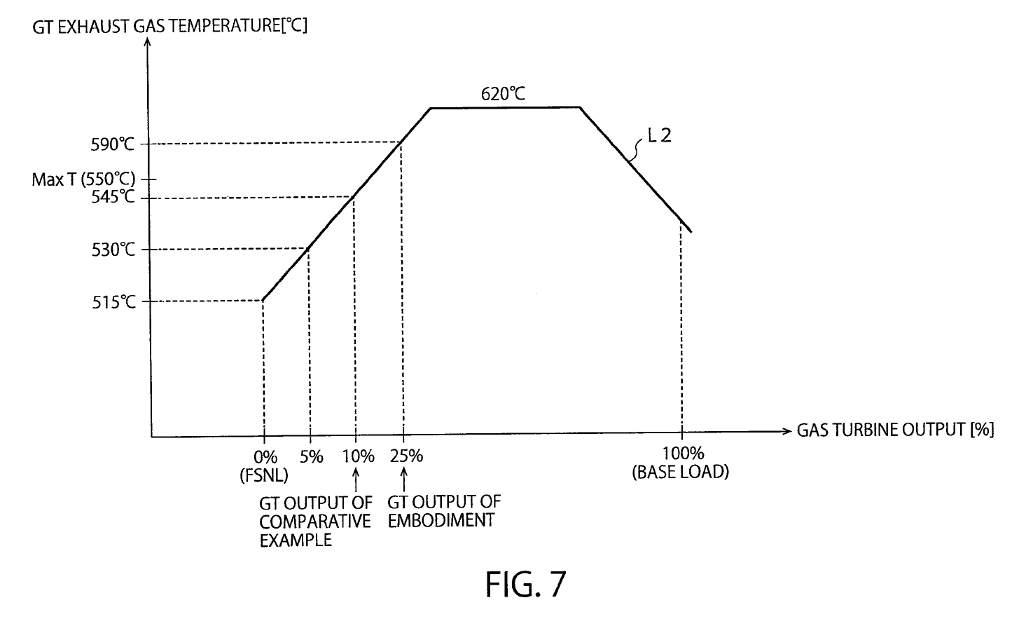

In the present comparative example and the present embodiment described later, there is an assumption that a relationship between a ratio (%) of gas turbine output to a rated output of the gas turbine and the GT exhaust gas temperature, shown in FIG. 7, is satisfied. That is, it is assumed that while the gas turbine 502 has properties in which a maximum exhaust gas temperature is 620° C., a maximum operating temperature MaxT of the heat exchanger 511 is set at 550° C.

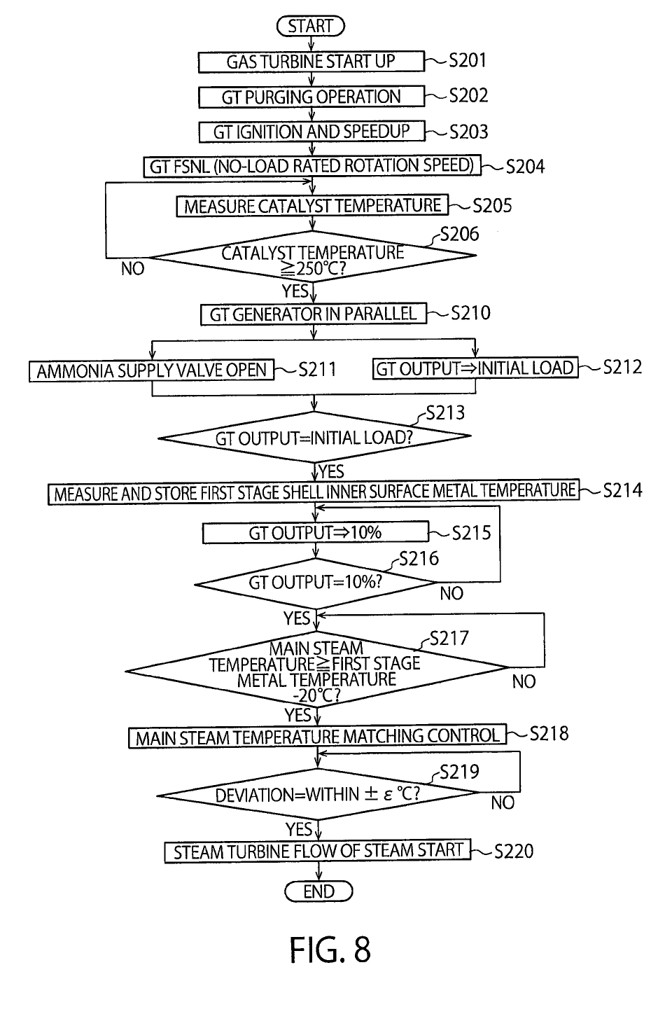

The plant control apparatus 601 stores a program that achieves the plant starting-up method shown in FIG. 8 in advance, and reads out and executes the program.

Subsequently, with reference to FIG. 8, a method of starting up the combined cycle power generation plant 600 in accordance with the comparative example will be described. FIG. 8 is a flow chart showing a plant starting-up method in accordance with the comparative example.

First, when the gas turbine 502 is started up (step S201), purging operation is performed (step S202) so that the gas turbine 502 reaches a no-load rated rotation speed (hereinafter a state where a rotation speed of the gas turbine is a no-load rated rotation speed is referred to as a full speed no load state (FSNL state)) (step S204) through a process of ignition and speedup of the gas turbine 502 (step S203). At that time, the GT exhaust gas “a” discharged from the gas turbine 502 includes NOx generated by combustion. However, a temperature of a denitrification catalyst is still low in an initial stage of a process of the startup, so that even if the ammonia gas “c” is injected, denitrification catalytic efficiency is low due to an extremely low amount of ammonia that reacts with NOx. As a result, it is impossible to inject the ammonia gas “c” from that time.

Accordingly, as with Japanese Patent No. 3281130, it is considered that the amount of the fuel 516 in the FSNL state is relatively low, so that a flow rate of NOx to be discharged is also low. Specifically, after the gas turbine 502 is shifted to the FSNL state, processing does not immediately proceed to a subsequent process in which a gas turbine generator is started up in parallel, and the FSNL state is held for warming-up of the exhaust heat recovery boiler 504 and the denitrification catalyst 520.

With reference to the warming-up process, when the GT exhaust gas “a” flows into the exhaust heat recovery boiler 504, heat of the GT exhaust gas “a” is first taken by heat recovery of the evaporator 509 and the heat exchanger 511, arranged in front of the denitrification catalyst 520 (on a left side of the denitrification catalyst 520 in FIG. 6). As a result, heat is hardly transmitted to the denitrification catalyst 520.

While the FSNL state is continued, heat is gradually transmitted up to the denitrification catalyst 520, so that a temperature measured by the catalyst temperature sensor TS4 rises. In the present comparative example, if the FSNL state is held for about one hour, the denitrification catalyst 520 is heated up to a temperature of 250° C. at which the denitrification catalytic efficiency is stabilized.

The catalyst temperature sensor TS4 then measures a catalyst temperature (step S205). If a temperature measured by the catalyst temperature sensor TS4 is 250° C. or more, namely a temperature of the denitrification catalyst 520 is 250° C. or more (YES at S206), the plant control apparatus 601 allows the generator 517 to be operated in parallel (step S210).

If an output of the gas turbine 502 is increased by allowing the generator 517 to be operated in parallel in a state where the denitrification catalytic efficiency is low other than the present plant starting-up method, a large amount of fuel 516 is burned without an injection of the ammonia gas “c” to generate a large amount of NOx that is not allowable for environmental conservation.

After the generator 517 starts operating in parallel, the ammonia supply valve 519 is opened (step S211). Accordingly, the plant control apparatus 601 increases the gas turbine output to an initial load to prevent reverse electric power from occurring (step S212). In this startup process, the ammonia gas “c” is discharged into the GT exhaust gas “a”. The ammonia gas “c” then reacts with NOx in the exhaust gas in the denitrification catalyst 520 to decompose and remove the NOx.

In preparation for a startup process (a flow of steam described before) in which, after the gas turbine output reaches the initial load, the control valve 505 is opened to allow main steam to flow into the steam turbine 503, the plant control apparatus 601 acquires and stores a measured metal temperature of an inner surface of a first stage shell (step S214). At the time of the initial load, since the main steam “b” has a temperature that is not high enough, a flow of steam of the steam turbine 503 is not allowed.

Accordingly, in order to heat the main steam to quickly increase a temperature of the main steam “b” up to a temperature at which a flow of steam is allowed (hereinafter referred to as warming-up), the plant control apparatus 601 increases the gas turbine output so that the GT exhaust gas temperature becomes a maximum within a range without exceeding the maximum operating temperature of the heat exchanger 511 (step S215). In this stage, since the amount of the main steam generated is low in the heat exchanger 511, the amount of heat of the GT exhaust gas to be taken by the main steam is low. As a result, heating without steam may occur in the heat exchanger 511. Thus, the present comparative example prevents the heat exchanger 511 from being heated without steam. That is, the GT exhaust gas temperature itself is controlled so as to be less than the maximum operating temperature of the heat exchanger 511. Specifically, there is selected a gas turbine output that allows the GT exhaust gas temperature to be 545° C. with a margin of 5° C. for 550° C. of the maximum operating temperature of heat exchanger 511. Specifically, with reference to the relationship of FIG. 7, a 10% output allows the GT exhaust gas temperature to be within a range without exceeding the maximum operating temperature of the heat exchanger 511.

When a temperature of the main steam rises up to a temperature below a metal temperature of the inner surface of the first stage shell by 20° C. by quickly performing warming-up while maintaining the 10% of gas turbine output, a subsequent startup process of main steam temperature matching control is started (step S218). In the main steam temperature matching control, a target GT exhaust gas temperature is given by the following: a metal temperature of an inner surface of a first stage shell+ΔT, where ΔT is predetermined temperature deviation.

In the present comparative example, a case where the target GT exhaust gas temperature is 530° C. is described, for example. With reference to the relationship of FIG. 8, the target GT exhaust gas temperature is achieved by 5% of gas turbine output. That is, when the temperature of the main steam rises up to a temperature below a metal temperature of the inner surface of the first stage shell by 20° C. by quickly increasing the temperature of the main steam while maintaining the 10% of gas turbine output, the main steam temperature matching control (step S218) is started. The main steam temperature matching control reduces the gas turbine output to 5% so that the GT exhaust gas temperature comes close to the target temperature of 530° C.

If fuel supply is continued, the temperature of the main steam gradually rises as time elapses to gradually come close to the metal temperature of an inner surface of a first stage shell.

The plant control apparatus 601 determines whether a deviation between the metal temperature of the inner surface of the first stage shell and the temperature of the main steam is within a range of ±ε° C. (step S219), where ε is a sufficiently small allowable deviation. If the deviation between the metal temperature of the inner surface of the first stage shell and the temperature of the main steam is within the range of ±ε° C. (YES at step S219), the plant control apparatus 601 allows the control valve 505 to open to start a flow of steam of the steam turbine 503 (step S220).

As above, in the present comparative example, in order to perform warming-up to quickly increase a temperature of the main steam “b” up to a temperature at which a flow of steam is allowed, the plant control apparatus 601 increases the gas turbine output so that the GT exhaust gas temperature becomes a maximum within a range without exceeding the maximum operating temperature of the heat exchanger 511. However, in this case, since startup time of a combined cycle power generation plant depends on the gas turbine output, it is impossible to shorten the startup time more than a capability of the gas turbine.

### First Embodiment

In the first embodiment, a plant control apparatus and a plant starting-up method, capable of shortening a startup time of a combined cycle power generation plant as compared with the comparative example will be described. Hereinafter, the embodiment of the present invention is described with reference to drawings.

First, an outline of the present embodiment will be described. The embodiment is created with a focus on two technical points below by merging the two technical points.

A first technical point is extracted from a plant starting-up method described in Japanese Patent No. 3281130. The plant starting-up method presented in Japanese Patent No. 3281130 provides an operation method of reducing a flow rate of NOx to be discharged in the atmosphere from an exhaust heat recovery boiler in view of environmental conservation. In the plant starting-up method described in Japanese Patent No. 3281130, there is provided a startup process of maintaining the FSNL state with a low flow rate of NOx discharged from a gas turbine in a startup process of a combined cycle power generation plant before a gas turbine generator is operated in parallel to perform gas turbine load operation.

In the first technical point, the gas turbine generator is operated in parallel after a temperature of a denitrification catalyst is sufficiently increased during the FSNL state to secure sufficient denitrification catalytic efficiency.

Subsequently, a second technical point will be described. In a case where an exhaust heat recovery boiler generates main steam, the main steam achieves an effect of cooling the heat exchanger 511 from the inside of a tube of the heat exchanger 511. Thus, in the second technical point, the gas turbine output is controlled so that an exhaust gas temperature (hereinafter referred to as a GT exhaust gas temperature) of the gas turbine exceeds the maximum operating temperature of the heat exchanger 511, as well as a temperature of the heat exchanger 511 becomes the maximum operating temperature thereof or less by using a cooling effect given by the main steam.

Hereinafter, the heat exchanger 511 of the exhaust heat recovery boiler 504 and the maximum operating temperature of the heat exchanger 511 will be described in detail. First, the heat exchanger 511 of the exhaust heat recovery boiler 504 is typically a tube (heat transfer pipe) such as a superheater and a reheater. Other than that, the heat exchanger 511 is a general term of a heat exchanger composed of components such as a header and connection piping.

As shown in FIG. 7, an output by which the GT exhaust gas temperature becomes a maximum is not a rated 100% output, but an output in an intermediate range. In this output range, a startup process of the combined cycle power generation plant has considerably proceeded. As a result, the combined cycle power generation plant is in an operation state in which a flow of steam of a steam turbine has already started, and a large amount of the main steam occurs from the heat exchanger 511 of the exhaust heat recovery boiler. Accordingly, the main steam achieves an effect of cooling the heat exchanger 511 from the inside thereof.

At the time of design of the heat exchanger 511, size, material, thickness, and the like are determined from viewpoints of the GT exhaust gas temperature, temperature of inside fluid (such as main steam), physical strength, initiation stress, economical efficiency required for a commercial machine, and the like. As a result, a temperature of the heat exchanger 511 is stabilized at a temperature close to a temperature of the main steam passing through the inside of the heat exchanger 511. In general, the temperature of the heat exchanger 511 becomes the highest in an outer surface portion with which an exhaust gas from the gas turbine (hereinafter referred to as a GT exhaust gas) is directly brought into contact.

The maximum operating temperature of the heat exchanger 511 is determined in consideration of the GT exhaust gas temperature in the operation above and a flow rate of the inside fluid so that a necessary and sufficient margin is added. For example, in an exhaust heat recovery boiler in combination with a gas turbine having properties in which the maximum temperature of the GT exhaust gas temperature is within a range from 600° C. to 650° C., the maximum operating temperature of the heat exchanger 511 is set within a range from about 550° C. to 600° C. Due to cooling effect of the main steam described above, operation at a GT exhaust gas temperature more than the maximum operating temperature of the heat exchanger 511 is allowable.

Although there is a difference in a level of the cooling effect by passing through of the main steam, the cooling effect is provided not only in a state where the gas turbine is in the operating state by an intermediate output described before, but also in a state where the gas turbine is in an initial startup process in which the gas turbine burns supplied fuel because the main steam is expected to occur regardless of amount. The initial startup process is a process before a flow of steam of the steam turbine is started, and in the process the gas turbine is operating in the FSNL state or by a low output.

In that case, since the amount of steam passing through the inside of the heat exchanger 511 is low, the temperature of the heat exchanger 511 becomes close to the GT exhaust gas temperature instead of the temperature close to the main steam temperature described above.

In this way, a target output of the gas turbine is controlled so that, in the initial startup process, the GT exhaust gas temperature becomes the maximum operating temperature of the heat exchanger 511 or more, as well as the temperature of the heat exchanger 511 becomes less than the maximum operating temperature of the heat exchanger 511 because the heat exchanger 511 is cooled by an effect of the main steam that has already occurred. As a result, the main steam temperature reaches to a target temperature earlier, so that it is possible to shorten startup time accordingly.

However, the exhaust heat recovery boiler has a large heat capacity. Accordingly, even if fuel supply to the gas turbine is continued, in some cases it takes a long time within a range of about 30 minutes to one hour until a sufficient flow rate of the main steam occurs.

In the plant starting-up method in the present embodiment, during a period held in the FSNL state for warming-up of a denitrification catalyst, latency of occurrence of the main steam is also performed to allow the gas turbine generator to be operated in parallel when a measured generated flow rate of the main steam becomes a prescribed generated flow rate thereof or more. The prescribed generated flow rate is a generated flow rate of the main steam after the gas turbine is held in a no-load rated rotation speed state for a prescribed time. When the generated flow rate of the main steam is the prescribed generated flow rate, a predetermined cooling effect is provided.

In a subsequent startup process in which gas turbine output is increased, gas turbine output is controlled so that, while startup time is shortened by increasing the GT exhaust gas temperature to a high temperature exceeding the maximum operating temperature of the heat exchanger 511, a temperature of the heat exchanger 511 becomes less than the maximum operating temperature of the heat exchanger 511 by using the cooling effect given by the main steam.

(Configuration of Combined Cycle Power Generation Plant 500)

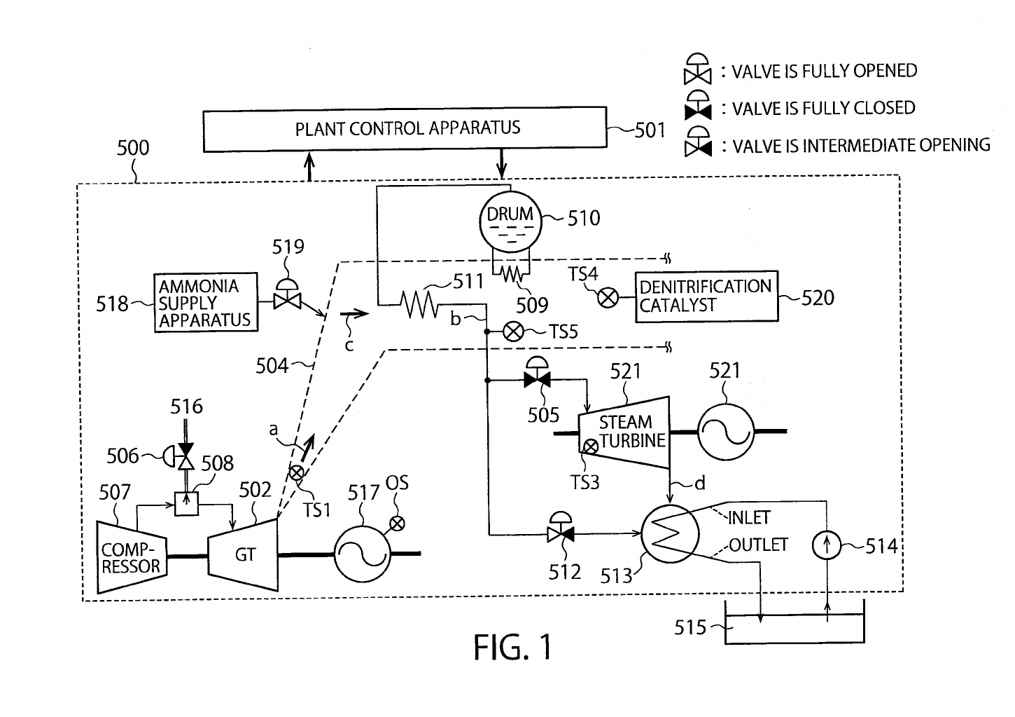

Subsequently, a configuration of the combined cycle power generation plant 500 in accordance with the first embodiment will be described with reference to FIG. 1. FIG. 1 is a schematic structural view showing a configuration of a combined cycle power generation plant 500 of the first embodiment.

The combined cycle power generation plant 500 shown in FIG. 1 is configured by adding a main steam flow rate sensor TS5 to the configuration of the combined cycle power generation plant 600 of the comparative example shown in FIG. 6. The main steam flow rate sensor TS5 detects a flow rate of the main steam “b” flowing through piping connecting the heat exchanger 511 and the control valve 505 at a prescribed time interval.

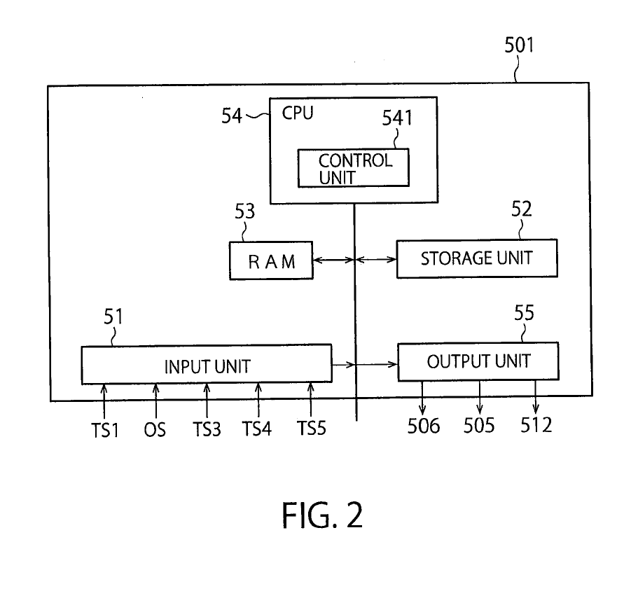

FIG. 2 is a schematic structural view showing a configuration of a plant control apparatus 501 of the first embodiment. The plant control apparatus 501 includes an input unit 51, a storage unit 52, a random access memory (RAM) 53, a central processing unit (CPU) 54, and an output unit 55.

The input unit 51 receives a signal of sensor measurement measured by each of sensors provided in the combined cycle power generation plant 500, and outputs the received signal of sensor measurement to the CPU 54.

Specifically, for example, the input unit 51 receives an exhaust gas temperature signal showing the GT exhaust gas temperature from the exhaust gas temperature sensor TS1 that measures the GT exhaust gas temperature, and outputs the received exhaust gas temperature signal to the CPU 54.

In addition, the input unit 51, for example, receives an inner surface metal temperature signal showing a metal temperature of an inner surface of a first stage shell from an inner surface metal temperature sensor TS3 that measures the metal temperature of the inner surface of the first stage shell, and outputs the received inner surface metal temperature signal to the CPU 54.

Further, the input unit 51, for example, receives a catalyst temperature signal showing a temperature of the denitrification catalyst 520 from the catalyst temperature sensor TS4 that measures the temperature of the denitrification catalyst 520, and outputs the received catalyst temperature signal to the CPU 54.

Furthermore, the input unit 51, for example, receives a main steam flow rate signal showing a flow rate of the main steam from the main steam flow rate sensor TS5 that measures the flow rate of the main steam, and outputs the received main steam flow rate signal to the CPU 54.

Further yet, the input unit 51, for example, receives a GT output signal showing an output of the gas turbine from the GT output sensor OS that measures the output of the gas turbine, and outputs the received GT output signal to the CPU 54.

The storage unit 52 stores a program for controlling the combined cycle power generation plant 500.

The RAM 53 temporarily stores information.

The CPU 54 reads out the program from the storage unit 52 to the RAM and executes the program to serve as a control unit 541. The control unit 541 controls the combined cycle power generation plant 500.

For example, the control unit 541 controls output of the gas turbine 502. At that time, the control unit 541 controls the fuel control valve 506 through the output unit 55 to adjust the amount of the fuel 516 to be supplied to the gas turbine 502. Since there is a proportional relation between opening/closing of the fuel control valve 506 and the output of the gas turbine 502, the control unit 541 can control the output of the gas turbine 502 by controlling the fuel control valve 506.

For another example, the control unit 541 controls the control valve 505 and the turbine bypass control valve 512 through the output unit 55.

The output unit 55 outputs a control signal received from the control unit 541 to the gas turbine 502, the control valve 505, and the turbine bypass control valve 512.

(Plant Starting-Up Method in Accordance with Present Embodiment)

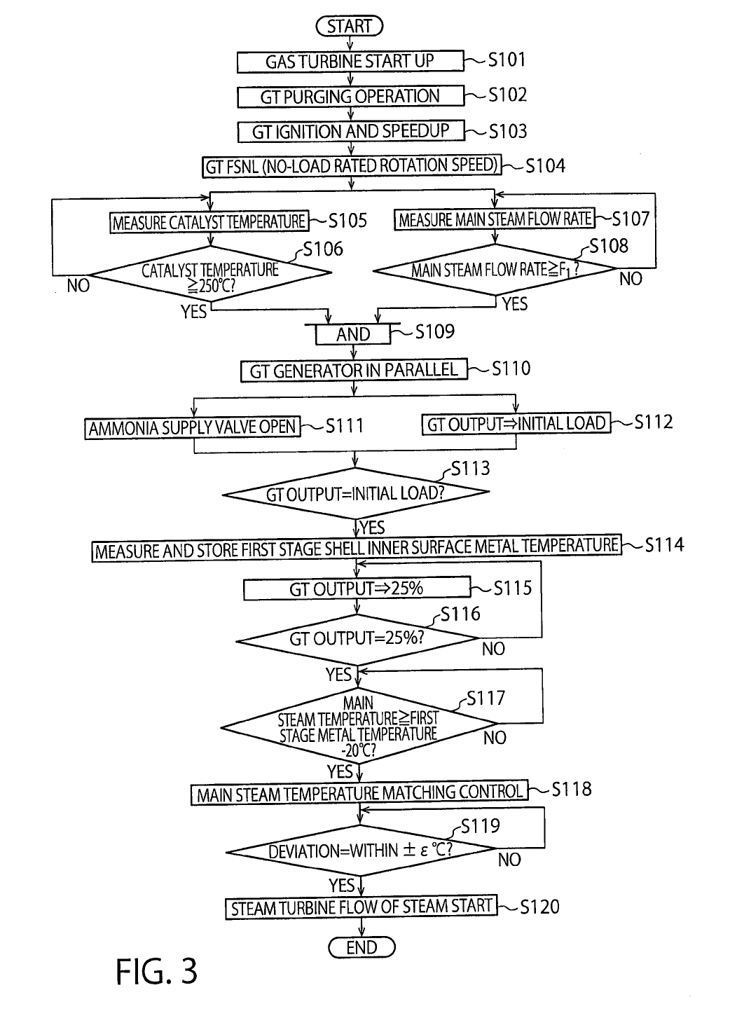

With reference to FIG. 3, a plant starting-up method of the combined cycle power generation plant 500 in accordance with the first embodiment will be described. FIG. 3 is a flow chart showing the plant starting-up method in accordance with the first embodiment.

In the present embodiment, as with the comparative example, the gas turbine 502 has properties in which the maximum exhaust gas temperature is 620° C., and the maximum operating temperature of the heat exchanger 511 is set at 550° C., and also the gas turbine 502 has the relationship between the gas turbine output (%) and the GT exhaust gas temperature, shown in FIG. 7. In addition, it takes one hour until a temperature of the denitrification catalyst 520 increases up to 250° C. by warming-up operation in the FSNL state.

First, when the gas turbine 502 is started up (step S101), purging operation is performed (step S102) so that the gas turbine 502 reaches the FSNL state (step S104) through a process of ignition and speedup of the gas turbine 502 (step S103). At this point, the GT exhaust gas “a” discharged from the gas turbine 502 includes NOx generated by combustion, however, a temperature of a denitrification catalyst is still low in an initial stage of a process of the startup, so that even if the ammonia gas “c” is injected, denitrification catalytic efficiency is low due to an extremely low amount of ammonia that reacts with NOx. As a result, it is impossible to inject the ammonia gas “c” from that time.

Accordingly, as with Japanese Patent No. 3281130, it is considered that the amount of the fuel 516 in the FSNL state is relatively low, so that a flow rate of NOx to be discharged is also low. After the gas turbine 502 is shifted to the FSNL state, processing does not immediately proceed to a subsequent process in which a gas turbine generator is started up in parallel, and the FSNL state is held for warming-up of the exhaust heat recovery boiler 504 and the denitrification catalyst 520.

That is, the catalyst temperature sensor TS4 measures a catalyst temperature (step S105), and the plant control apparatus 501 determines whether the catalyst temperature is 250° C. or more by using a catalyst temperature signal (step S106). With reference to the warming-up process, when the GT exhaust gas “a” flows into the exhaust heat recovery boiler 504, heat of the GT exhaust gas “a” is first taken by heat recovery of the evaporator 509 and the heat exchanger 511, arranged in front of the denitrification catalyst 520 (on a left side in FIG. 1). As a result, heat is hardly transmitted to the denitrification catalyst 520. While the FSNL state is continued, heat is gradually transmitted up to the denitrification catalyst 520, so that a temperature of the denitrification catalyst 520 rises. If the FSNL state is held for one hour, the denitrification catalyst 520 is heated up to a temperature of 250° C. at which the denitrification catalytic efficiency is stabilized.

As an index showing that the denitrification catalytic efficiency is stabilized, a temperature of the GT exhaust gas “a” measured by a temperature sensor provided in an inlet of the denitrification catalyst 520 may be used instead of a temperature measured by the catalyst temperature sensor TS4. In this case, the plant control apparatus 501 may consider that the denitrification catalytic efficiency is stabilized when the measured temperature of the GT exhaust gas “a” is equal to or more than a prescribed threshold value.

While the FSNL state is held for the one hour, the amount of evaporation gradually increases in the evaporator 509 of the exhaust heat recovery boiler 504 to allow the main steam “b” to occur from the drum 510. The main steam “b” is supplied to the steam condenser 513 through the turbine bypass control valve 512. The main steam flow rate sensor TS5 measures a flow rate of the main steam “b” (step S107), and the control unit 541 determines whether the flow rate of the main steam reaches a prescribed generated flow rate F₁ or more (step S108). The prescribed generated flow rate F₁ is an empirical value of a generated flow rate of main steam in a case where the gas turbine 502 is held in the FSNL state for a prescribed time (such as one hour).

If the FSNL state is held for one hour, a condition that a temperature of the denitrification catalyst 520 is 250° C. or more, and a condition that a main steam flow rate is equal to or more than the prescribed generated flow rate F₁, are satisfied almost at the same time. In step S109, the control unit 541 allows the generator 517 to be operated in parallel with the gas turbine 502 if both of the conditions above are satisfied (step S110).

In this way, before the generator 517 is started to be operated in parallel, the control unit 541 controls the gas turbine 502 so as to be held in a no-load rated rotation speed state until a measurement value of the generated flow rate of the main steam becomes the prescribed generated flow rate F₁ or more as well as a temperature of the denitrification catalyst 520 becomes a prescribed temperature (such as 250° C.) or more. Meanwhile, the control unit 541 allows the generator 517 to be operated in parallel with the gas turbine 502 when the measurement value of the generated flow rate of the main steam becomes the prescribed generated flow rate F₁ or more as well as the temperature of the denitrification catalyst 520 becomes the prescribed temperature or more.

In the present embodiment, although the control unit 541 determines whether to allow the generator 517 to be operated in parallel with the gas turbine on the basis of a measurement value of the generated flow rate of the main steam and a temperature of the denitrification catalyst, a determination method is not limited to the above. The control unit 541 may determine whether to allow the generator 517 to be operated in parallel with the gas turbine on the basis of only a measurement value of the generated flow rate of the main steam.

Specifically, before the generator 517 is started to be operated in parallel, control unit 541 may control the gas turbine 502 so as to be held in the no-load rated rotation speed state until a measurement value of the generated flow rate of the main steam becomes the prescribed generated flow rate F₁ or more. Meanwhile, the control unit 541 may allow the generator 517 to be operated in parallel with the gas turbine when a measurement value of the generated flow rate of the main steam becomes the prescribed generated flow rate or more.

After the generator 517 is started to be operated in parallel, the control unit 541 allows the ammonia supply valve 519 to open (step S111), as well as increases output of the gas turbine to an initial load to prevent reverse electric power from occurring (step S112). In this startup process, the ammonia gas “c” is injected into the GT exhaust gas “a”. As a result, the ammonia gas “c” reacts with NOx in the exhaust gas in the denitrification catalyst 520 to decompose and remove the NOx.

In preparation for a startup process in which, after the output of the gas turbine reaches the initial load, the control valve 505 is opened to allow steam to flow into the steam turbine 503, the control unit 541 acquires a measured metal temperature of an inner surface of a first stage shell and stores the measured metal temperature thereof in the storage unit 52 (step S114). At the time of the initial load, since the main steam “b” has a temperature that is not high enough, a flow of steam of the steam turbine 503 is not allowed.

Accordingly, also in the present embodiment, gas turbine output is increased to perform warming-up so that a temperature of the main steam “b” increases to a temperature at which a flow of steam is possible, as with the comparative example. In the comparative example, warming-up is performed by the 10% of gas turbine output that provides a GT exhaust gas temperature of 545° C. less than the maximum operating temperature of the heat exchanger 511. In contrast, in the present embodiment, warming-up is performed by increasing the gas turbine output to 25% that provides a GT exhaust gas temperature of 590° C. more than the maximum operating temperature of the heat exchanger 511 (step S115).

In this way, after the generator 517 is started to be operated in parallel with the gas turbine 502, the control unit 541 increases output of the gas turbine 502 up to a target output (such as 25%, for example). When output of the gas turbine is the target output, an exhaust gas temperature of the gas turbine 502 exceeds the maximum operating temperature of the heat exchanger 511, however, since a temperature of the heat exchanger 511 becomes less than the maximum operating temperature of the heat exchanger 511 by using a cooling effect given by the main steam, there is no problem in which a temperature of the heat exchanger exceeds the maximum operating temperature thereof. Accordingly, the output of the gas turbine is set at the target output above. More preferably, the target output is set at a maximum gas turbine output among gas turbine outputs that provide a temperature of the heat exchanger 511 less than the maximum operating temperature of the heat exchanger 511 by using the cooling effect given by the main steam.

After that, when output of the gas turbine becomes 25% (YES at step S116), the control unit 541 determines whether a main steam temperature becomes below a metal temperature of the inner surface of the first stage shell by 20° C. or more while maintaining the 25% of gas turbine output (step S117). When the main steam temperature becomes below the metal temperature of the inner surface of the first stage shell by 20° C. or more (YES at step S117), the control unit 541 starts main steam temperature matching control (step S118) in a subsequent startup process. In the present embodiment, it is assumed that a target temperature of the GT exhaust gas is 530° C., and a gas turbine output is 5% according to the relationship shown in FIG. 7, as with the comparative example. That is, when the main steam temperature matching control (step S118) is started while the gas turbine output is held at 25%, the gas turbine output is reduced to 5% by the present matching control. Since processing in subsequent step S119 and S120 is identical with processing in step S219 and S220 in the comparative example shown in FIG. 8, description of step S119 and S120 is omitted.

In this way, in the present embodiment, warming-up is performed at 25% of gas turbine output, for example, so that it is possible to shorten time required to increase the main steam temperature to a temperature below a metal temperature of the inner surface of the first stage shell by 20° C. as compared with the comparative example. As a result, it is possible to shorten startup time.

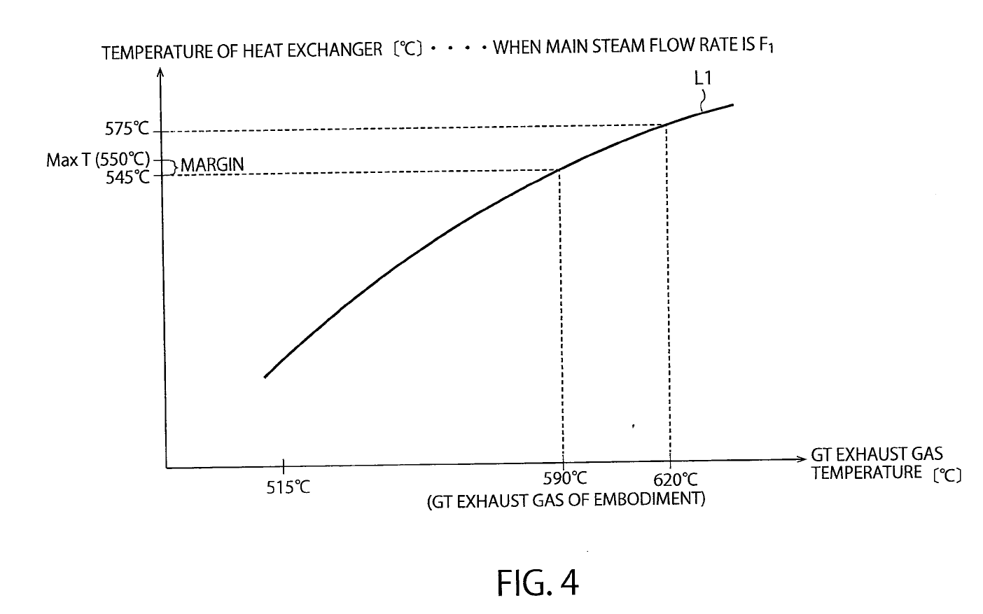

Hereinafter, grounds for selection and a calculation method of the prescribed generated flow rate F₁ of main steam and the 25% of gas turbine output will be described. FIG. 4 is a graph showing a relationship between GT exhaust gas temperature and the temperature of the heat exchanger 511 at a main steam generated flow rate F₁. In a case where main steam has the prescribed generated flow rate F₁, it is assumed that a temperature of the heat exchanger 511 is set at 545° C. with a margin of 5° C. for the maximum operating temperature MaxT of the heat exchanger 511 (such as 550° C., for example). In that case, in order to allow the temperature of the heat exchanger 511 to be 545° C., the GT exhaust gas temperature is required to be 590° C. from a curve L1 indicating a relationship between the temperature of the heat exchanger 511 and the GT exhaust gas temperature, shown in FIG. 4. In addition, in order to allow the GT exhaust gas temperature to be 590° C., the gas turbine output is required to be set at 25% from a curve L2 indicating a relationship between the GT exhaust gas temperature and the gas turbine output, shown in FIG. 7. Accordingly, in a case where the main steam has the prescribed generated flow rate F₁, the 25% is selected as the gas turbine output.

As described above, when the main steam “b” has already occurred to pass through the inside of the heat exchanger 511, the main steam “b” provides a cooling effect to allow the temperature of the heat exchanger 511 to be an intermediate temperature between the main steam temperature and the GT exhaust gas temperature. The temperature of the heat exchanger 511 depends on three parameters that are the GT exhaust gas temperature, a GT exhaust gas flow rate, and a main steam flow rate. Since the main steam temperature is determined by the GT exhaust gas temperature, the GT exhaust gas flow rate, and the main steam flow rate, only each of the three parameters serve as an independent parameter.

In the present embodiment, the following four aspects are focused on.

First, in an operation range in which gas turbine output is relatively low (about 30% or less of output) described in the present embodiment, an inlet guide vane (IGV) that adjusts the amount of suction air of a gas turbine compressor is held at a fixed opening. Thus, even if output fluctuates in the operation range, the GT exhaust gas flow rate is almost constant. Accordingly, if the GT exhaust gas flow rate is fixed, the temperature of the heat exchanger 511 depends on two parameters that are the GT exhaust gas temperature and the main steam flow rate.

Second, the present embodiment intends to shorten startup time so that a startup method has mechanism of shortening the startup time, the mechanism being relatively easily understood. Before the generator 517 is started to be operated in parallel, the present embodiment and the comparative example have the same holding time of the FSNL state that is one hour. In this way, it is easily understood that a difference between the 25% of gas turbine output of the present embodiment and the 10% of gas turbine output of the comparative example, after the generator 517 is started to be operated in parallel, directly contributes to shortening of the startup time.

Thus, when the present embodiment is planned, the prescribed main steam generated flow rate F₁ in a case where the FSNL state is continued for one hour is first calculated and selected on the basis of a heat equilibrium plan (may be called heat balance) of the combined cycle power generation plant 500, and calculated and selected by using a technique such as dynamic simulation, if necessary. Here, the heat balance is a state quantity (such as a temperature, a pressure, an enthalpy, and a flow rate) of an inlet and an outlet of each of components included in the combined cycle power generation plant 500.

Accordingly, the startup process simultaneously satisfies the temperature of the denitrification catalyst 520 that is 250° C. or more, and the main steam flow rate that is the prescribed generated flow rate F₁ or more.

This aspect intends to eliminate latency of only occurrence of the main steam flow rate by performing also latency of occurrence of the main steam using a holding period in the FSNL state for warming-up of the denitrification catalyst. Accordingly, the present embodiment is allowed to have the same time required for the startup process in the FSNL state as that of the comparative example so that an effect of shortening of the startup time by the 25% of the gas turbine output can be received in a subsequent startup process without reducing the effect.

Third, since the main steam flow rate in a state where the FSNL state is continued for one hour is the prescribed generated flow rate F₁, it is secured that the amount of the main steam flow rate equal to or more than the prescribed generated flow rate F₁ occurs in the subsequent startup process in which the generator 517 is operated in parallel to increase the gas turbine output. However, it takes time to increase a flow rate from the prescribed generated flow rate F₁ due to a large heat capacity of the heat recovery boiler 504.

Accordingly, in the present embodiment, the main steam flow rate, in a case where the gas turbine output is increased, is evaluated as the prescribed generated flow rate F₁ that is secured at least, and is fixed. As a result, it is possible to acquire a relationship in which the temperature of the heat exchanger 511 depends only on one parameter that is the GT exhaust gas temperature. As shown in the graph of FIG. 4, the relationship can be shown by like the curve L1 shown in FIG. 4 in which the GT exhaust gas temperature is indicated on the X-axis, and the temperature of the heat exchanger 511 in which the main steam flow rate is the prescribed generated flow rate F₁ is indicated on the Y-axis.

Fourth, even in the comparative example, in a case where the FSNL state is continued for one hour, the main steam flow rate is the prescribed generated flow rate F₁, as with the present embodiment. However, the present embodiment is provided with the main steam flow rate sensor TS5 to actually determine whether the main steam flow rate reaches the prescribed generated flow rate F₁ or more by measuring an actual flow rate of the main steam “b”. Accordingly, a cooling effect given by the main steam is secured, so that the control unit 541 can increase output of the gas turbine so as to increase the GT exhaust gas temperature up to 590° C. exceeding 550° C. of the maximum operating temperature of the heat exchanger 511.

In the comparative example, it had better avoid increasing output of the gas turbine so as to increase the GT exhaust gas temperature up to 590° C. on the basis of a premise that the prescribed generated flow rate F₁ occurs as the main steam flow rate, without measuring the main steam flow rate. That is, there is a possibility that the main steam flow rate may not reach the prescribed generated flow rate F₁ due to occurrence of accidental equipment failure, and aged deterioration, of the combined cycle power generation plant 500.

### Effect of Present Embodiment

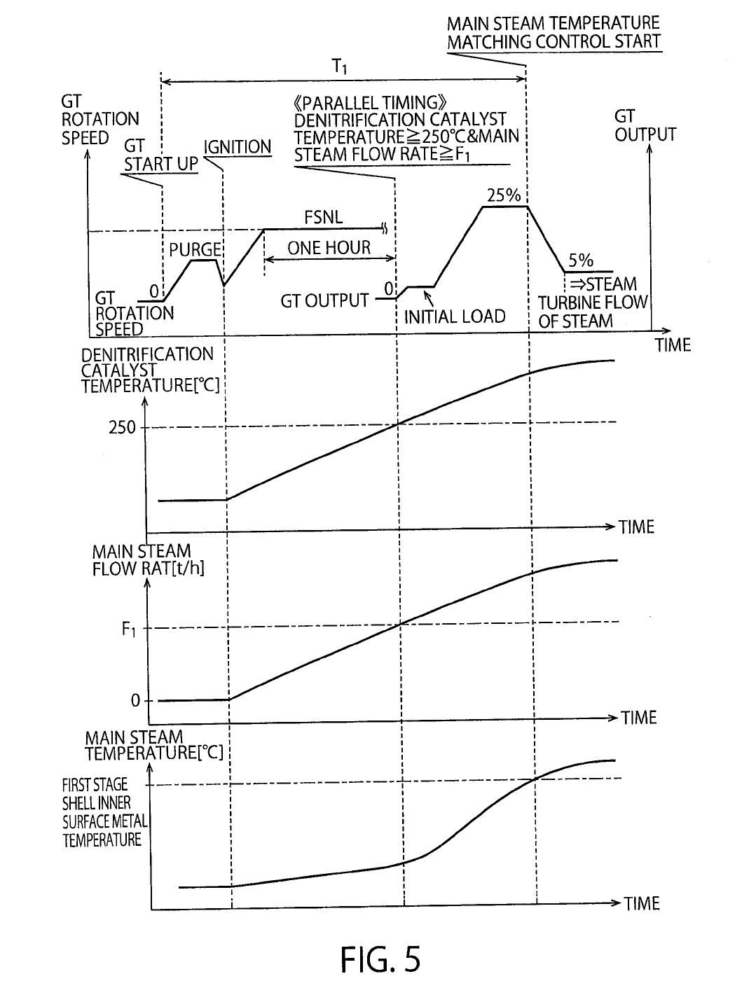

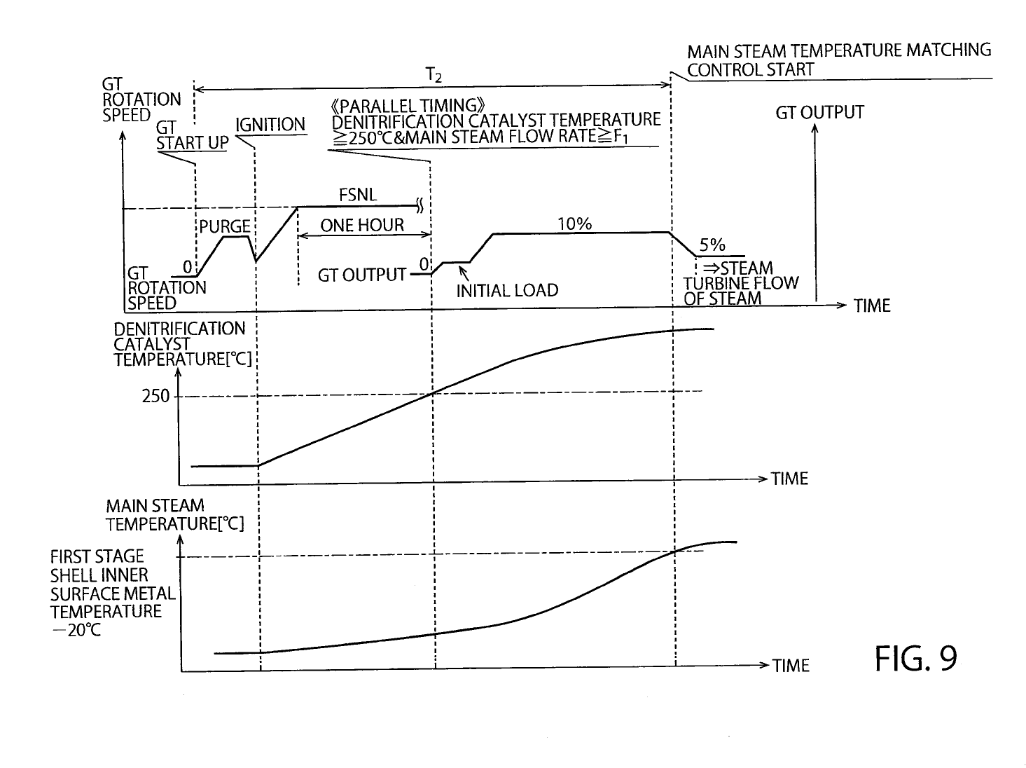

Subsequently, an effect of the present embodiment will be described by comparing FIG. 5 and FIG. 9. FIG. 5 is a startup chart of a plant starting-up method in accordance with the first embodiment, and FIG. 9 is a startup chart of a plant starting-up method in accordance with the comparative example. As shown in FIG. 5, in the present embodiment, the gas turbine output is increased up to 25% to perform warming-up in consideration of a cooling effect by occurrence of the main steam when the conditions described above are satisfied after the generator is operated in parallel. As a result, the main steam temperature rises with a steeper rate of change as compared with a case where warming-up is performed with an output of 10% as shown in FIG. 9. Comparing FIG. 5 and FIG. 9, in the present embodiment, time from start of operation of the generator 517 in parallel to start of the main steam temperature matching control is short as compared with the comparative example. As a result, time T₁ from the beginning of GT startup to the start of the main steam temperature matching control shown in FIG. 5 is shorter than time T₂ of that shown in FIG. 9, so that startup time in the present embodiment is reduced as compared with the comparative example.

As above, the plant control apparatus 501 in accordance with the first embodiment includes the control unit 541 that allows the gas turbine 502 to increase its output after the generator 517 is started to be operated in parallel with the gas turbine 502 until the output becomes a target output. The target output is set so that an exhaust gas temperature of the gas turbine 502 exceeds the maximum operating temperature of the heat exchanger 511, as well as a temperature of the heat exchanger 511 becomes the maximum operating temperature thereof or less by using a cooling effect given by the main steam.

In this way, after the generator 517 is started to be operated in parallel with the gas turbine 502, while in the comparative example, an exhaust gas temperature of the gas turbine is controlled so as not to exceed the maximum operating temperature of the heat exchanger, in the present embodiment, output of the gas turbine is set at a target output so that an exhaust gas temperature of the gas turbine exceeds the maximum operating temperature of the heat exchanger. Accordingly, since it is possible to increase the output of the gas turbine as compared with the comparative example, it is possible to shorten the time from the start of operation of the generator 517 in parallel to the start of the main steam temperature matching control. As a result, it is possible to shorten startup time of the combined cycle power generation plant 500 as compared with the comparative example.

In addition, before the generator 517 is started to be operated in parallel, the control unit 541 of the present embodiment controls the gas turbine 502 so that the gas turbine 502 is held in a no-load rated rotation speed state until a measurement value of a generated flow rate of the main steam becomes a prescribed generated flow rate or more. Meanwhile, when the measurement value of the generated flow rate of the main steam becomes the prescribed generated flow rate or more, the control unit 541 allows the generator 517 to be operated in parallel with the gas turbine 502. The prescribed generated flow rate is a generated flow rate of the main steam after the gas turbine 502 is held in the no-load rated rotation speed state for a prescribed time.

In this way, it is possible to increase the output of the gas turbine by waiting until a generated flow rate of the main steam is measured and the measured generated flow rate reaches a flow rate at which a cooling effect can be provided to the heat exchanger 511. As a result, the heat exchanger 511 can accept the GT exhaust gas temperature more than the maximum operating temperature thereof to shorten the startup time of the combined cycle power generation plant 500.

(First Variation)

Subsequently, a first variation will be described. In the present embodiment described before, the prescribed generated flow rate F₁ is selected as a main steam flow rate when a temperature of the denitrification catalyst 520 reaches 250° C. or more, and warming-up is performed by selecting an output of 25% allowable in accordance with a cooling effect of the main steam flow rate. In contrast, in the first variation, the main steam flow rate F₁′ at which a more cooling effect is provided is selected, and warming-up is performed by selecting a gas turbine output allowable in accordance with the cooling effect.

In the present embodiment described before, in order to allow a mechanism of shortening startup time in a startup method to be relatively easily understood, there is described a method, for example, that simultaneously satisfies both of a condition where a temperature of the denitrification catalyst 520 becomes 250° C. or more after the FSNL state is held for one hour, and a method, and a condition where the main steam flow rate is equal to or more than the prescribed generated flow rate F₁.

Meanwhile, there are various combinations of components of the combined cycle power generation plant 500, and there are various heat equilibrium plans of the combined cycle power generation plant 500. In a heat equilibrium plan of the first variation, the FSNL state is further extended for a prescribed time (such as fifteen minutes, for example) from when a temperature of the denitrification catalyst 520 reaches 250° C. or more, as well as the main steam flow rate reaches the prescribed generated flow rate F₁ or more, after the FSNL state is held for one hour. Accordingly, the main steam flow rate reaches the generated flow rate F₁′ that is more than the prescribed generated flow rate F₁ by holding the FSNL state for a total of one hour and fifteen minutes.

The generated flow rate F₁′ provides a cooling effect that is considerably larger than the cooling effect of the prescribed generated flow rate F₁. In the first variation, as with the present embodiment, a target output is preset at a maximum gas turbine output by which a temperature of the heat exchanger 511 does not exceed the maximum operating temperature by the cooling effect given by the generated flow rate F₁′. After the generator 517 is started to be operated in parallel with the gas turbine 502, the control unit 541 increases output of the gas turbine 502 up to the target output. The target output is equal to or more than the target output of 25% of the present embodiment. Accordingly, it is possible to increase the gas turbine output to 25% or more in warming-up after the start of operation of the generator 517 in parallel.

As a result, even if it takes further fifteen minutes in the FSNL state before start of operation of the generator 517 in parallel, it is possible to shorten a total startup time by shortening time required to allow the main steam temperature to reach a temperature below a metal temperature of the inner surface of the first stage shell by 20° C. in the warming-up after the start of operation of the generator 517 in parallel by fifteen minutes or more.

As above, before the generator 502 is started to be operated in parallel, the control unit 541 in the first variation controls the gas turbine 502 so as to be held in the no-load rated rotation speed state until it takes a prescribed time from when a measurement value of the generated flow rate of the main steam becomes the prescribed generated flow rate or more, as well as the temperature of the denitrification catalyst 520 becomes a prescribed temperature or more. Meanwhile, the control unit 541 allows the generator 517 to be operated in parallel with the gas turbine 502 in a case where a prescribed time elapses from when the measurement value of the generated flow rate of the main steam becomes the prescribed generated flow rate or more, as well as the temperature of the denitrification catalyst 520 becomes the prescribed temperature or more.

Accordingly, even if it takes an extra prescribed time in the FSNL state before start of operation of the generator 517 in parallel as compared with the present embodiment, it is possible to shorten a total startup time by shortening time required to allow the main steam temperature to reach a temperature below a metal temperature of the inner surface of the first stage shell by 20° C. in the warming-up after the start of operation of the generator 517 in parallel by the prescribed time or more.

Whether the present variation actually achieves shortening of the startup time depends on a heat equilibrium plan of the combined cycle power generation plant 500 that becomes a subject. As a result, the present variation may not be applicable to all plants.

(Second Variation)

Subsequently, a second variation will be described. In the present embodiment described before, warming-up is performed by increasing the gas turbine output up to a target output (such as 25%) by which a cooling effect by a main steam flow rate at which a temperature of the denitrification catalyst 520 reaches 250° C. or more is allowable. As described is the embodiment above, if a main steam flow rate at the time when the FSNL state is continued for one hour is the prescribed generated flow rate F₁, in a subsequent startup process in which the generator 517 is started to be operated in parallel with the gas turbine 502 to increase the gas turbine output to 25% so that the output of 25% is held for warming-up, a main steam flow rate equal to or more than the prescribed generated flow rate F₁ always occurs as holding time elapses.

Accordingly, in the second variation, the storage unit 52 stores a table including a plurality of sets of a generated flow rate and a target output, for example, in advance. In a plant starting-up method of the second variation, in a startup process in which warming-up is performed while a target output (such as 25%) is held, the control unit 541 acquires a measurement value of the main steam flow rate in any time period in which a main steam temperature does not reach a temperature below a metal temperature of the inner surface of the first stage shell by 20° C. yet.

If the measurement value is more than the prescribed generated flow rate F₁, that is if the main steam flow rate sensor TS5 detects a second generated flow rate F₂ that is larger than the prescribed generated flow rate F₁, the control unit 541 reads out a second target output corresponding to the second generated flow rate F₂ from the storage unit 52. The control unit 541 then increases the gas turbine output to the second target output. As a result, it is possible to increase the gas turbine output to the second target output larger than a target output (such as 25%) by using a cooling effect by the second generated flow rate F₂ that is larger than the cooling effect by the prescribed generated flow rate F₁. The gas turbine 502 then performs warming-up while holding output at the second target output.

The second target output is set so that an exhaust gas temperature of the gas turbine 502 exceeds a maximum operating temperature of the heat exchanger 511, as well as a temperature of the heat exchanger 511 becomes less than the maximum operating temperature of the heat exchanger 511 by using a cooling effect given by the main steam at the second generated flow rate F₂, in a case where output of the gas turbine 502 is the second target output as well as a generated flow rate of the main steam is the second generated flow rate F₂.

More preferably, the second target output is set at a maximum gas turbine output among gas turbine outputs that provide a temperature of the heat exchanger 511 less than the maximum operating temperature of the heat exchanger 511 by using the cooling effect given by the main steam at the second generated flow rate F₂.

As above, the control unit 541 in the second variation acquires a measurement value of the generated flow rate of the main steam in a state where the target output is held after output of the gas turbine 502 is increased to the target output to increase the output of the gas turbine 502 from the target output to the second target output corresponding to the measurement value.

As a result, since the second target output is larger than the target output, the main steam temperature can reach a temperature below a metal temperature of the inner surface of the first stage shell by 20° C. earlier as compared with the embodiment described already. Accordingly, it is possible to shorten startup time as compared with the embodiment described already.

In a modification of the second variation, after the output is increased to the second target output, the control unit 541 may acquire a measurement value of the generated flow rate of the main steam in any time period in which the main steam temperature does not reach a temperature below a metal temperature of the inner surface of the first stage shell by 20° C. yet. If the acquired measurement value is larger than the second generated flow rate F₂, that is, if the main steam flow rate sensor TS5 detects steam at a generated flow rate larger than the second generated flow rate F₂, the control unit 541 may increase the gas turbine output to output larger than the second target output.

(Third Variation)

Subsequently, a third variation will be described. In the third variation, it is assumed to apply hot startup in which restart is performed after a short idle period after the combined cycle power generation plant 500 is stopped to operation of a plant. In the hot startup, the denitrification catalyst 520, the evaporator 509, and the heat exchanger 511, have residual heat of previous operation. Accordingly, at the time when startup of the combined cycle power generation plant 500 starts, the condition where the temperature of the denitrification catalyst 520 is 250° C. or more is already satisfied. As a result, there is no latency of holding the FSNL state for one hour for performing warming-up of the denitrification catalyst.

Hereinafter, with reference to FIG. 8 described in the comparative example, a plant starting-up method of the third variation will be described. First, when the gas turbine 502 is started up (step S201), purging operation is performed (step S202) so that the gas turbine 502 reaches the FSNL state (step S204) through a process of ignition and speedup of the gas turbine 502 (step S203).

At the time, if the catalyst temperature sensor TS4 measures a catalyst temperature (step S205), the catalyst temperature sensor TS4 measures a temperature of 250° C. or more immediately after the measurement is started. As a result, holding of the FSNL state is eliminated, and the control unit 541 immediately allows the generator 517 to be operated in parallel with the gas turbine 502 (step S210).

After the generator 517 is started to be operated in parallel with the gas turbine 502, in order to prevent reverse electric power from occurring in the gas turbine 502, the control unit 541 allows the ammonia supply valve 519 to open (step S221) as well as increases the output of the gas turbine 502 to an initial load (step S212). The temperature of the denitrification catalyst 520 is already 250° C. or more, so that even if holding of the FSNL state before, the start of operation of the generator 517 in parallel is eliminated, denitrification control is performed without a trouble.

After the start of operation of the generator 517 in parallel, the gas turbine output is increased to a third target output (such as 10%, for example) through an initial load to perform warming-up while the gas turbine output is held at the third target output. When the main steam temperature rises up to a temperature below a metal temperature of the inner surface of the first stage shell by 20° C., a subsequent startup process of main steam temperature matching control is started (step S118).

Providing supplementary explanation on the third target output (such as 10%) in the hot startup, the main steam “b” has a tendency to occur earlier because residual heat in the evaporator 509 and the heat exchanger 511 can be used in the hot startup. However, at the time when the output of the gas turbine 502 is increased to the third target output (within a few minutes from the start of operation of the generator 517 in parallel in time course), the amount of the main steam “b” is insufficient to cause lack of a cooling effect of the heat exchanger 511.

Thus, the third target output is set at a gas turbine output (such as 10%) that provides a maximum GT exhaust gas temperature without exceeding the maximum operating temperature (such as 550° C.) of the heat exchanger 511.

As above, both of the comparative example and the third variation have the same startup process until warming-up is started to increase the main steam temperature up to a temperature below a metal temperature of the inner surface of the first stage shell by 20° C. while the gas turbine output is held at 10%. However, as described below, the third variation is different from the comparative example in a plant starting-up method after a warming-up process is started.

Hereinafter, the plant starting-up method of the third variation after the warming-up process is started will be described. In the third variation, in a startup process in which warming-up is performed while the third target output (such as 10%) is held, the control unit 541 acquires a measurement value of the main steam generated flow rate as a fourth generated flow rate in any time period in which a main steam temperature does not reach a temperature below a metal temperature of the inner surface of the first stage shell by 20° C. yet.

The control unit 541 then increases the output of the gas turbine 502 from the third target output to a fourth target output corresponding to the fourth generated flow rate. The gas turbine 502 then performs warming-up while holding output at the fourth target output.

The fourth target output is set so that an exhaust gas temperature of the gas turbine 502 exceeds a maximum operating temperature of the heat exchanger 511, as well as a temperature of the heat exchanger 511 becomes less than the maximum operating temperature of the heat exchanger 511 by using a cooling effect given by the main steam at the fourth generated flow rate, in a case where output of the gas turbine 502 is the fourth target output as well as a generated flow rate of the main steam is the fourth generated flow rate.

More preferably, the fourth target output is set at a maximum gas turbine output among gas turbine outputs that are larger than the third target output (such as 10%), and that provide a temperature of the heat exchanger 511 less than the maximum operating temperature of the heat exchanger 511 by using the cooling effect given by the main steam at the fourth generated flow rate.

Hereinafter, for convenience of explanation, the prescribed generated flow rate F₁ described in the embodiment described already is selected as the fourth generated flow rate. As described in the embodiment described already, a maximum gas turbine output by which a temperature of the heat exchanger 511 does not exceed the maximum operating temperature of the heat exchanger 511 by using the cooling effect given by the main steam at the prescribed generated flow rate F₁ is 25%, so that the fourth target output in this case is 25%.

Accordingly, in warming-up of the third variation, if the prescribed generated flow rate F₁ is detected when the warming-up is performed while the gas turbine output is held at 10%, the control unit 541 increases the gas turbine output to 25%.

(Effect of Third Variation)

As above, after the generator 517 is started to be operated in parallel with the gas turbine 502, the control unit 541 in the third variation increases the output of the gas turbine 502 to the third target output by which an exhaust gas temperature of the gas turbine 502 does not exceed the maximum operating temperature of the heat exchanger 511.

In addition, the control unit 541 acquires a measurement value of the generated flow rate of the main steam as the fourth generated flow rate in a state where the output of the gas turbine 502 is held at the third target output to increase the output of the gas turbine 502 from the third target output to the fourth target output corresponding to the fourth generated flow rate.

Here, the fourth target output is set so that an exhaust gas temperature of the gas turbine exceeds the maximum operating temperature of the heat exchanger 511, as well as a temperature of the heat exchanger 511 becomes less than the maximum operating temperature of the heat exchanger 511 by using the cooling effect given by the main steam at the fourth generated flow rate, in a case where output of the gas turbine is the fourth target output as well as a generated flow rate of the main steam is the fourth generated flow rate.

In the comparative example, warming-up is performed while the third target output (such as 10%) is held constant. In contrast, in the third variation, warming-up is performed by increasing output to the fourth target output (such as 25%) in the middle of the warming-up. Accordingly, in the third variation, the main steam temperature reaches a temperature below a metal temperature of the inner surface of the first stage shell by 20° C. earlier as compared with the comparative example, so that it is possible to shorten the time from the start of operation of the generator 517 in parallel to the start of the main steam temperature matching control as compared with the comparative example. As a result, it is possible to shorten startup time as compared with the comparative example.

For reference, the third variation and the embodiment described already will be compared below. This comparison corresponds to comparison between hot startup and cold startup. In the embodiment described already, it waits until a main steam flow rate reaches the prescribed generated flow rate F₁ while the FSNL state in which the GT exhaust gas temperature is low is held. On the other hand, in the third variation, it waits until a main steam flow rate reaches the prescribed generated flow rate F₁ while an output of 10% in which the GT exhaust gas temperature is high is held, so that it is possible to shorten the startup time as compared with the embodiment described already.

As described above, although the prescribed generated flow rate F₁ is selected as the fourth generated flow rate, the selection is only an example. In view of shortening of startup time, a flow rate less than the prescribed generated flow rate F₁ should be selected as the fourth generated flow rate for a more advantageous plant starting-up method.

Accordingly, in a startup process in which an output of 10% is held, a main steam flow rate reaches the fourth generated flow rate in less time, so that it is possible to increase output from the third target output (such as 10%) to the fourth target output in less time.

(Fourth Variation)

The control unit 541 may perform the following processing in addition to the processing of the third variation described above. Here, there is a premise that the storage unit 52 stores a table including a plurality of sets of a generated flow rate and a target output, for example, in advance.

In a state where output of a gas turbine is increased to the fourth target output and then the fourth target output is held, the control unit 541 acquires a measurement value of the generated flow rate of the main steam in any time period in which the main steam temperature does not reach a temperature below a metal temperature of the inner surface of the first stage shell by 20° C. yet. If the measurement value is more than the fourth generated flow rate, that is if the steam flow rate sensor TS5 detects a fifth generated flow rate that is larger than the fourth generated flow rate, the control unit 541 reads out a fifth target output corresponding to the fifth generated flow rate from the storage unit 52. The control unit 541 then increases the gas turbine output to the read-out fifth target output. The gas turbine 502 then performs warming-up while holding output at the fifth target output.

As above, in a state where output of the gas turbine 502 is increased to the fourth target output and then the output of the gas turbine 502 is held at the fourth target output, the control unit 541 acquires a measurement value of the generated flow rate of the main steam as the fifth generated flow rate. If the fifth generated flow rate is more than the fourth generated flow rate, the control unit 541 increases the output of the gas turbine from the fourth target output to the fifth target output corresponding to the fifth generated flow rate.

The fifth target output is set so that an exhaust gas temperature of the gas turbine 502 exceeds a maximum operating temperature of the heat exchanger 511, as well as a temperature of the heat exchanger 511 becomes less than the maximum operating temperature of the heat exchanger 511 by using a cooling effect given by the main steam at the fifth generated flow rate, in a case where output of the gas turbine 502 is the fifth target output as well as a generated flow rate of the main steam is the fifth generated flow rate.

In the third variation, warming-up is performed by increasing output to the fourth target output (such as 25%) in the middle of the warming-up. In contrast, in the fourth variation, the gas turbine 502 increases its output to the fourth target output (such as 25%) in the middle of warming-up, and then further increases its output to the fifth target output to perform the warming-up. Accordingly, the main steam temperature reaches a temperature below a metal temperature of the inner surface of the first stage shell by 20° C. earlier as compared with the third variation, so that it is possible to shorten time from start of operation of the generator 517 in parallel to start of the main steam temperature matching control as compared with the third variation. As a result, it is possible to shorten startup time as compared with the third variation.

More preferably, the fifth target output is set at a maximum gas turbine output among gas turbine outputs that are larger than the fourth target output, and that provide a temperature of the heat exchanger 511 less than the maximum operating temperature of the heat exchanger 511 by using the cooling effect given by the main steam at the fifth generated flow rate.

Accordingly, the gas turbine 502 is operated at the maximum gas turbine output among gas turbine outputs that provide a temperature of the heat exchanger 511 less than the maximum operating temperature of the heat exchanger 511 by using the cooling effect given by the main steam at the fifth generated flow rate. As a result, it is possible to further shorten the time from the start of operation of the generator 517 in parallel to the start of the main steam temperature matching control, so that it is possible to further shorten the startup time.

The control unit 541 may repeat processing of the control unit 541 in the fourth variation at a prescribed time interval, for example. At that time, a subsequent target output is set at a maximum gas turbine output among gas turbine outputs that are larger than the current target output, and that provide a temperature of the heat exchanger 511 less than the maximum operating temperature of the heat exchanger 511 by using the cooling effect given by the main steam at a generated flow rate measured by the steam flow rate sensor TS5. Accordingly, the gas turbine 502 is operated at a maximum gas turbine output among gas turbine outputs that provide a temperature of the heat exchanger 511 less than the maximum operating temperature of the heat exchanger 511 by using a cooling effect given by main steam at a main steam flow rate at that time. As a result, it is possible to further shorten the time from the start of operation of the generator 517 in parallel to the start of the main steam temperature matching control, so that it is possible to further shorten the startup time.

Various types of processing described above of the plant control apparatus 501 in accordance with the present embodiment may be performed as follows: a program for executing each processing the plant control apparatus 501 of the present embodiment is recorded in a computer-readable recording media; a computer system reads out the program recorded in the recording medium; and a processor executes the program.

While certain embodiments have been described, these embodiments have been presented by way of example only, and are not intended to limit the scope of the inventions. Indeed, the novel apparatuses and methods described herein may be embodied in a variety of other forms; furthermore, various omissions, substitutions and changes in the form of the apparatuses and methods described herein may be made without departing from the spirit of the inventions. The accompanying claims and their equivalents are intended to cover such forms or modifications as would fall within the scope and spirit of the inventions.

1. A plant control apparatus configured to control a combined cycle power generation plant, the plant comprising:
a gas turbine;
an exhaust heat recovery boiler including an evaporator configured to recover heat from an exhaust gas discharged from the gas turbine to generate steam, and a heat exchanger configured to exchange heat between the steam and an exhaust gas from the gas turbine to heat the steam and generate main steam; and
a steam turbine configured to be driven by the main steam generated by the heat exchanger,
the apparatus comprising a control unit configured to increase output of the gas turbine to a target output after the gas turbine is paralleled with a generator,
wherein the target output is set so that an exhaust gas temperature of the gas turbine exceeds a maximum operating temperature of the heat exchanger and that a temperature of the heat exchanger becomes the maximum operating temperature of the heat exchanger or less by using a cooling effect given by the main steam.

2. The apparatus of claim 1, wherein
the control unit controls the gas turbine so that the gas turbine is held in a no-load rated rotation speed state until a measurement value of a generated flow rate of the main steam becomes a prescribed generated flow rate or more before the gas turbine is paralleled with the generator, and
the control unit allows the gas turbine to be paralleled with the generator when the measurement value of the generated flow rate of the main steam becomes the prescribed generated flow rate or more.

3. The apparatus of claim 2, wherein
the plant comprises a denitrification apparatus configured to mix an exhaust gas discharged from the gas turbine with an ammonia gas, and decompose and remove nitrogen oxide in the exhaust gas by using a denitrification catalyst,
the control unit controls the gas turbine so that the gas turbine is held in the no-load rated rotation speed state until the measurement value becomes a prescribed generated flow rate or more as well as a temperature of the denitrification catalyst becomes a prescribed temperature or more before the gas turbine is paralleled with the generator, and
the control unit allows the gas turbine to be paralleled with the generator when the measurement value becomes the prescribed generated flow rate or more as well as the temperature of the denitrification catalyst becomes the prescribed temperature or more.

4. The apparatus of claim 2, wherein
the plant comprises a denitrification apparatus configured to mix an exhaust gas discharged from the gas turbine with an ammonia gas, and decompose and remove nitrogen oxide in the exhaust gas by using a denitrification catalyst,
the control unit controls the gas turbine so that the gas turbine is held in the no-load rated rotation speed state until a prescribed time elapses from when a measurement value of a generated flow rate of the main steam becomes a prescribed generated flow rate or more as well as a temperature of the denitrification catalyst becomes a prescribed temperature or more before the gas turbine is paralleled with the generator, and
the control unit allows the gas turbine to be paralleled with the generator if a prescribed time elapses from when the measurement value becomes the prescribed generated flow rate or more as well as the temperature of the denitrification catalyst becomes the prescribed temperature or more.

5. The apparatus of claim 1, wherein
the control unit acquires a measurement value of a generated flow rate of the main steam in a state where output of the gas turbine is increased to the target output and then the target output is held, to increase the output of the gas turbine from the target output to a second target output corresponding to the measurement value, and
in a case where the output of the gas turbine is the second target output as well as the generated flow rate of the main steam is a second generated flow rate, the second target output is set so that an exhaust gas temperature of the gas turbine exceeds a maximum operating temperature of the heat exchanger as well as a temperature of the heat exchanger becomes the maximum operating temperature of the heat exchanger or less by using a cooling effect given by main steam at the second generated flow rate.

6. A plant control apparatus configured to control a combined cycle power generation plant, the plant comprising:
a gas turbine;
an exhaust heat recovery boiler including an evaporator configured to recover heat from an exhaust gas discharged from the gas turbine to generate steam, and a heat exchanger configured to exchange heat between the steam and an exhaust gas from the gas turbine to heat the steam and generate main steam; and
a steam turbine configured to be driven by the main steam generated by the heat exchanger,
the apparatus comprising a control unit configured to control output of the gas turbine,
wherein
the control unit increases the output of the gas turbine to a first target output by which an exhaust gas temperature of the gas turbine does not rise to a maximum operating temperature of the heat exchanger after the gas turbine is paralleled with a generator,
in a state where the output of the gas turbine is held at the first target output, the control unit acquires a measurement value of a generated flow rate of the main steam as a second generated flow rate to increase the output of the gas turbine from the first target output to a second target output corresponding to the second generated flow rate, and
in a case where the output of the gas turbine is the second target output as well as the generated flow rate of the main steam is the second generated flow rate, the second target output is set so that an exhaust gas temperature of the gas turbine exceeds the maximum operating temperature of the heat exchanger as well as a temperature of the heat exchanger becomes the maximum operating temperature of the heat exchanger or less by using a cooling effect given by the main steam at the second generated flow rate.

7. The apparatus of claim 6, wherein
the control unit acquires a measurement value of the generated flow rate of the main steam as a third generated flow rate in a state where the output of the gas turbine is increased to the second target output and then the output of the gas turbine is held at the second target output, and the control unit increases, in a case where the third generated flow rate is more than the second generated flow rate, the output of the gas turbine from the second target output to a third target output corresponding to the third generated flow rate, and
in a case where the output of the gas turbine is the third target output as well as the generated flow rate of the main steam is the third generated flow rate, the third target output is set so that an exhaust gas temperature of the gas turbine exceeds the maximum operating temperature of the heat exchanger as well as a temperature of the heat exchanger becomes the maximum operating temperature of the heat exchanger or less by using a cooling effect given by main steam at the third generated flow rate.

8. A plant starting-up method of a combined cycle power generation plant, the plant comprising:
a gas turbine;
an exhaust heat recovery boiler including an evaporator configured to recover heat from an exhaust gas discharged from the gas turbine to generate steam, and a heat exchanger configured to exchange heat between the steam and an exhaust gas from the gas turbine to heat the steam and generate main steam;
a steam turbine configured to be driven by the main steam generated by the heat exchanger,
the method comprising controlling, by using a control unit, output of the gas turbine so as to be a target output after the gas turbine is paralleled with a generator; and
wherein in a case where the output of the gas turbine is the target output, the target output is set so that an exhaust gas temperature of the gas turbine exceeds a maximum operating temperature of the heat exchanger and that a temperature of the heat exchanger becomes the maximum operating temperature of the heat exchanger or less by using a cooling effect given by the main steam.

9. A plant starting-up method of a combined cycle power generation plant, the plant comprising:
a gas turbine;
an exhaust heat recovery boiler including an evaporator configured to recover heat from an exhaust gas discharged from the gas turbine to generate steam, and a heat exchanger configured to exchange heat between the steam and an exhaust gas from the gas turbine to heat the steam and generate main steam;
a steam turbine configured to be driven by the main steam generated by the heat exchanger,
the method comprising:
increasing, by using a control unit, output of the gas turbine to a first target output by which an exhaust gas temperature of the gas turbine does not exceed a maximum operating temperature of the heat exchanger after the gas turbine is paralleled with a generator;
acquiring, by using the control unit, a measurement value of a generated flow rate of the main steam as a second generated flow rate in a state where the output of the gas turbine is held at the first target output, to increase the output of the gas turbine from the first target output to a second target output corresponding to the second generated flow rate,
wherein in a case where the output of the gas turbine is the second target output as well as the generated flow rate of the main steam is the second generated flow rate, the second target output is set so that an exhaust gas temperature of the gas turbine exceeds the maximum operating temperature of the heat exchanger as well as a temperature of the heat exchanger becomes the maximum operating temperature of the heat exchanger or less by using a cooling effect given by the main steam at the second generated flow rate.
